(19) United States
(12) Patent Application Publication
(10) Pub. No.: US 2001/0014857 A1
(43) Pub. Date: Aug. 16, 2001

(54) A VOICE ACTIVITY DETECTOR FOR PACKET VOICE NETWORK

(76) Inventor: ZIFEI PETER WANG, THOUSAND OAKS, CA (US)

Correspondence Address: BLAKELY SOKOLOFF TAYLOR & ZAFMAN, 12400 WILSHIRE BOULEVARD, SEVENTH FLOOR, LOS ANGELES, CA, 900251026

(21) Appl. No.: 09/134,272

(22) Filed: Aug. 14, 1998

(51) Int. Cl. G10L 15/00

(52) U.S. Cl. 704/231

(57) ABSTRACT

A voice activity detector to analyze a short-term averaged energy (STAE), a long-term averaged energy (LTAE), and a peak-to-mean likelihood ratio (PMLR) in order to determine whether a current audio frame being transmitted represents voice or silence. This is accomplished by determining whether a sum of the STAE and a factor is greater than the LTAE. If not, the current audio frame represents silence. If so, a second set of determinations is performed. Herein, a determination is made as to whether the difference between the LTAE and the STAE is less than a predetermined threshold. If so, the current audio frame represents voice. Otherwise, the PMLR is determined and compared to a selected threshold. If the PMLR is greater than the selected threshold, the current audio frame represents a voice signal. Otherwise, it represents silence.

### BACKGROUND

1. Field

The present invention relates to the field of data communications. In particular, this invention relates to a system and method for enhancing the reliability of voice activity detection.

2. General Background

For many years, discontinuous transmission (DTX) systems have been installed to conserve bandwidth over packet voice/data networks. Bandwidth conservation is accomplished by detecting when a caller is speaking and transmitting speech packets generated by a speech coder during those periods of time. For the remaining periods of time when the caller is not speaking, certain DTX systems have been configured to transmit a background noise level tracked by a voice activating detector. This background noise level is subsequently used to replicate the background silence gaps between communications, which are a considerable portion of normal speech communications.

Conventional DTX systems consist of a voice activity detector (VAD) and a comfort noise generator (CNG). Normally, a “voice activity detector” (VAD) is software processed by circuitry to digitize an analog signal (e.g., voice and/or background noise) and to determine whether or not a particular segment of the digitized analog signal represents a person's voice. Since the range of a person's voice is dynamic, in some situations varying 20-40 decibels (dB), and background noise can vary moment to moment, a number of different parameters have been used by conventional VADs to discern voice activity.

For example, an IEEE publication entitled “Application of an LPC distance measure to the voice-unvoiced-silence detection problem,” authored by L. R. Rabiner and M. R. Sambur, describes a voice activity detector (VAD) performing a pattern recognition approach on incoming digitally sampled signals to detect voice activity. In particular, this VAD creates templates of parameters for voiced, unvoiced (e.g., tailing off sounds for certain words) and silence segments of speech. Each template includes five parameters: the energy of the signal (Eₛ); the zero-crossing rate of the signal (N_{z}); the autocorrelation coefficient at unit sample delay (C₁); the first order predictor coefficient (A₁); and the normalized prediction error (Eₚ). Through probability calculations, decision logic compares the templates with a sampled segment of an incoming signal to determine whether the segment represents voice, unvoice or silence. The disadvantage associated with this VAD is that it is extremely difficult to find a set of reliable templates to distinguish between a variety of speech signals and numerous levels of background noise found in different environments.

Another example of VAD involves the use of linear prediction coefficients (LPC) which are calculated in the speech coder. While taking advantage of the LPCs calculated in the speech coders reduce computational power consumption by the VAD, it also has encountered a number of disadvantages. For example, speech coders in accordance with the International Telegraph and Telephone Consultive Committee (CCITT) G.729B standards perform linear predictive coding differently than speech coders in accordance with CCITT G.723 standards. As a result, there does not exist a VAD which can be used by virtually all types of speech coders. Instead, depending on the type of speech coder implemented, the VAD must be modified to operate in combination with that speech coder. This increases overall ownership costs and the difficulty in upgrading the DTX system.

Over the last few years, MICOM Communications Corporation of Simi Valley, Calif., has produced voice/data networking products for DTX systems that utilize a universal energy-based VAD. The voice/data networking products includes a dual-mode speech coding function in order to achieve bandwidth efficiency. In a VOICE mode, a selected speech coder is responsible for compressing voice signals before transmission and for decompressing the voice signals upon reception. In a SILENCE SUPPRESSION mode, only the background noise level signal is transmitted, from which white noise is regenerated at the destination.

Currently, two parameters are used by this universal VAD function in order to determine whether the voice/data networking product is operating in a VOICE mode or a SILENCE SUPPRESSION mode. These parameters include (i) short-term tracking energy and (ii) long-term tracking energy. The “short-term tracking energy” is an accumulation of signal energy associated with voice signaling and background noise level, and thus, is represented by equation (1).

Eₜᵣₖ(k)=α×E_{db}(k)+(1−α)×Eₜᵣₖ(k−1), (1)

where

$$α = \{ \begin{matrix}\frac{1}{4} & if {E}_{db} ( k ) \geq {E}_{trk} ( k - 1 ) , or \\ \frac{1}{8} & otherwise .\end{matrix}$$

E_{dB}(k) denotes the current frame energy in decibels and is equivalent to the following:

$$10 {log}_{10} ( {\sum }_{n = 0}^{n = N - 1} {( s ( n ) )}^{2} )$$

where “N” represents the number of samples per frame.

Eₜᵣₖ(k−1) denotes the short-term tracking energy for the previous frame.

The “long-term tracking energy” represents the background noise level associated with incoming audio and is measured by equation (2).

E₁(k)=min{βE₁(k−1)+(1−β)Eₛ(k),Eₘₐₓ}, (2)

where

β=0.875; and

Eₘₐₓ denotes the maximum background level.

As a result, when the calculated value of the long-term tracking energy approaches the calculated value of the short-term tracking energy, the VAD predicts that a segment of sampled signals associated with a current frame is likely to be silence. One problem that has been encountered is that this conventional VAD is subject to increased switching between VOICE mode and SILENCE SUPPRESSION mode during long periods of silence, where the long-term tracking energy naturally approaches the short-term tracking energy. This increasing switching, referred to as “in/out effects,” causes audio volume fluctuations detectable by the human ear.

Hence, it would be advantageous to provide a system and method for enhancing reliability of voice activity detection through development of an improved, universal VAD which relies on a peak-to-mean likelihood ratio. The peak-to-mean likelihood ratio reduces the occurrence of the in/out effects by further assisting the VAD, in certain instances, to determine whether an incoming analog signal represents voice or silence.

### SUMMARY OF THE INVENTION

The present invention relates to a voice activity detector, being either software executable by a processing unit or firmware, which predicts whether an audio frame represents a voice signal or silence. This prediction is based the analysis of a number of parameters, including a short-term averaged energy (STAE), a long-term averaged energy (LTAE), and a peak-to-mean likelihood ratio (PMLR).

In one embodiment, to predict whether a frame represents voice or silence, an initial determination is made whether a sum of the STAE and a factor is greater than the LTAE. If the sum is less than the LTAE, the audio frame represents silence. Otherwise, a second determination is made as to whether the difference between the LTAE and the STAE is less than a predetermined threshold. In the event that the difference between the LTAE and the STAE is less than the predetermined threshold, the PMLR is determined and compared to a selected threshold. If the PMLR is greater than the selected threshold, the audio frame represents a voice signal. Otherwise, it represents silence.

### BRIEF DESCRIPTION OF THE DRAWINGS

The features and advantages of the present invention will become apparent from the following detailed description of the present invention in which:

FIG. 1 is an illustrative diagram of a system comprising a first networking device operating in accordance with the present invention.

FIG. 2 is an illustrative diagram of an embodiment of a communication module employed within the first networking device of FIG. 1.

FIG. 3 is an illustrative flowchart of the operations of the first networking device of FIG. 1.

FIG. 4 is an illustrative block diagram of the data structure of a service frame.

FIG. 5 is an illustrative block diagram of the data structure of a silence suppression frame.

FIG. 6 is an illustrative flowchart of the operations of the second networking device.

FIG. 7 is an illustrative block diagram of the operations of the comfort noise generator.

FIG. 8 is an illustrative flowchart of the operations of the voice activating detector.

FIG. 9 is an illustrative block diagram of hardware for calculating the average peak-mean ratio.

FIG. 10 is an illustrative block diagram of a state diagram of a decision smoothing state machine for further reduction of in/out effects.

### DETAILED DESCRIPTION OF AN EMBODIMENT

Herein, embodiments of the present invention relates to a system and method for enhancing reliability in voice activity detection. This is accomplished by an improved voice activity detector in which an additional parameter, a peak-to-mean likelihood ratio (PMLR), is used in combination with long-term averaged energy and short-term averaged energy parameters to determine whether various segments of audio constitute voice or silence. The use of the peak-to-mean likelihood ratio by the voice activity detector will reduce audio degradation currently experienced by conventional DTX systems.

Herein, certain terminology is used to describe various features of the present invention. In general, a “system” comprises one or more networking devices coupled together through corresponding signal lines. A “networking device” comprises a digital platform such as, for example, a MARATHON™ frame relay product by Nortel/MICOM, a voice-over Asynchronous Transfer Mode (ATM) product such as Passport 4740™ by Nortel/MICOM, cellular telephones operating in accordance with a cellular communication standard (e.g., GSM) and the like. Such a digital platform usually comprises software and/or hardware to perform analog to linear conversion, echo cancellation, speed coding, etc. A “signal line” includes any communications link capable of transmitting digital information at some ascertainable bandwidth. Examples of a signal line include a variety of mediums such as T1/E1, frame relay, private leased line, satellite, microwave, fiber optic, cable, wireless communications (e.g., radio frequency “RF”) or even a logical link.

Additionally, “information” generally comprises a signal having one or more bits of data, address, control or any combination thereof. A “communication module” includes a voice activity detector used to determine whether various segments of audio constitute voice or silence. In this embodiment, the “voice activity detector” (VAD) is software; however, it is contemplated that the VAD may be implemented in its entirety as hardware or firmware being a combination of hardware and software.

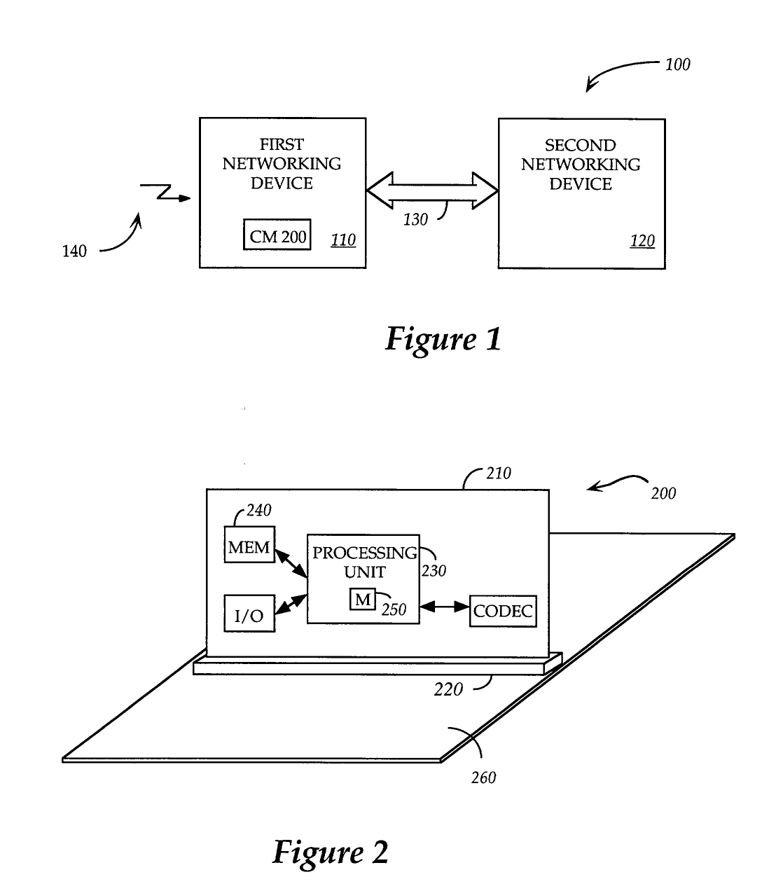

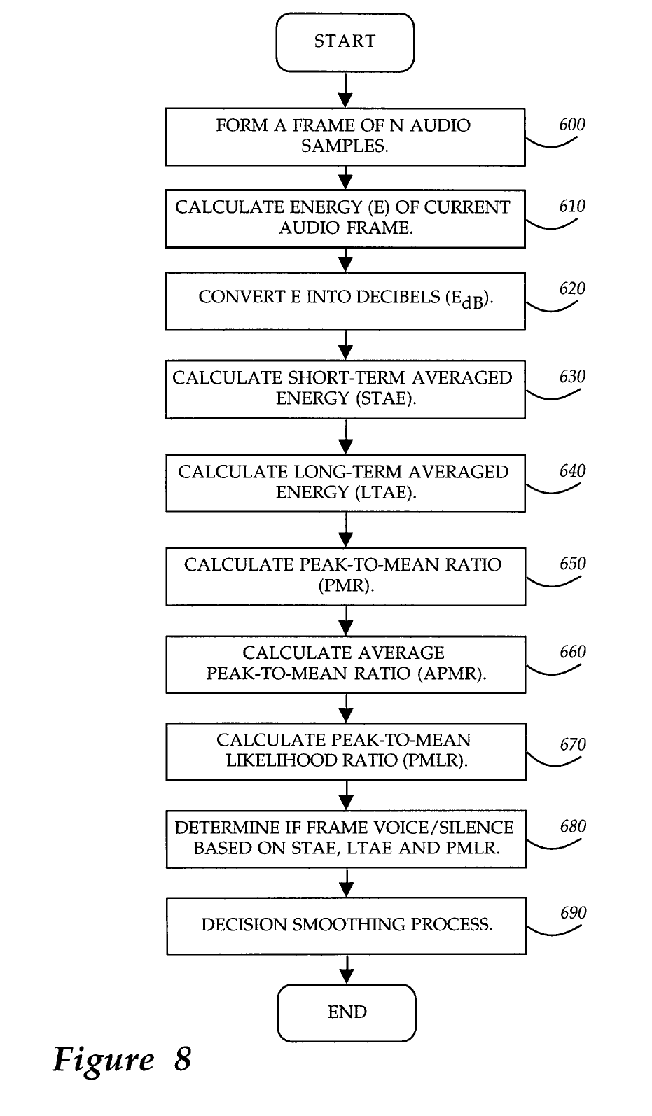

Referring to FIG. 1, an illustrative embodiment of a system utilizing the present invention is shown. Herein, system 100 includes a first networking device (source) 110 coupled to a second networking device (destination) 120 via a signal line 130. Herein, networking device 110 receives analog audio signals 140 as input and digitizes the audio to produce pulse code modulation (PCM) audio for example. The PCM audio is separated into multiple frames, where various signal characteristics of each frame are analyzed by a voice activating detector (VAD) as described below in FIG. 8. From these signal characteristics, first networking device 110 can determine whether to transmit a compressed audio frame (referred to as a “service frame”) or to transmit a silence suppression frame providing a noise background level as described below.

Referring now to FIG. 2, first networking device 110 comprises a communication module 200. Communication module 200 includes a substrate 210 which is formed with any type of material or combination of materials upon which integrated circuit (IC) devices can be attached. Communication module 200 is adapted to a connector 220 in order to exchange information with other logic mounted on a circuit board 260 of networking device 110 for example. Any style for connector 220 may be used, including a standard female edge connector, a pin field connector, a socket, a network interface card (NIC) connection and the like.

As shown, communication module 200 includes memory 230 and a processing unit 240. In this embodiment, memory 230 includes off-chip volatile memory to contain software which, when executed by processing unit 240, performs voice activity detection. Of course, non-volatile memory may be used in combination with or in lieu of volatile memory. Processing unit 240 includes, but is not limited or restricted to a general purpose microprocessor, a digital signal processor, a micro-controller or any other logic having software processing capabilities. Processing unit 240 includes on-chip internal memory (M) 250 to receive information from memory 230 for internal storage thereby enhancing its processing speed.

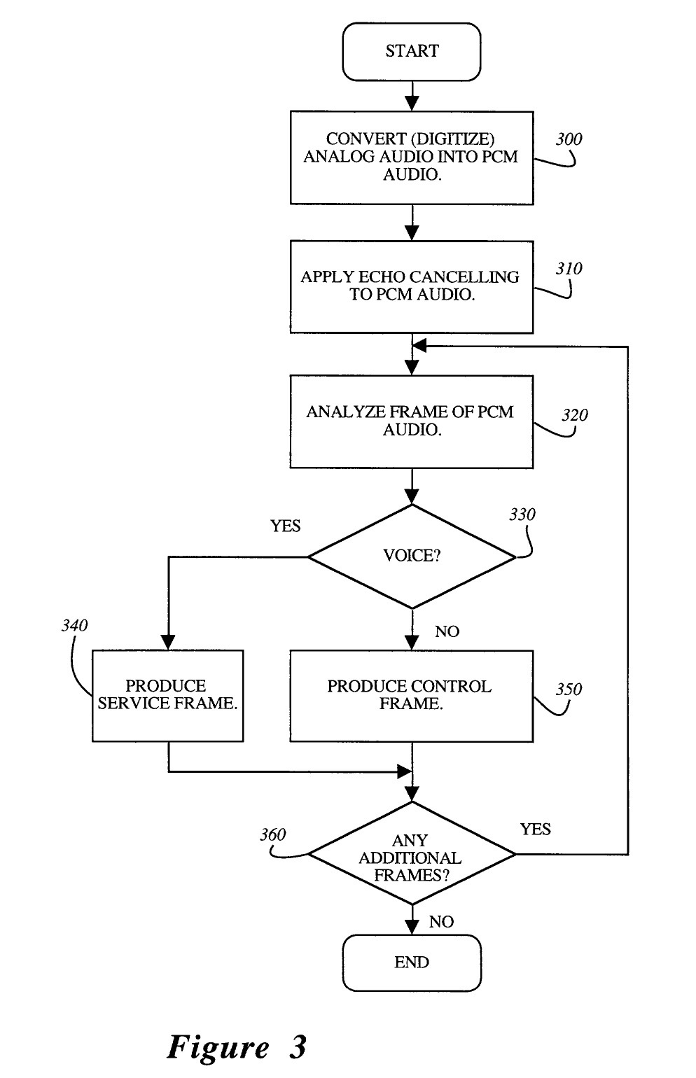

Referring now to FIG. 3, an illustrative flowchart of the operations performed by first networking device 110 is shown. Initially, first networking device 110 receives analog audio and digitizes the audio. For this example, the audio may be converted into PCM audio (block 300). The PCM audio is modified by an echo canceler (block 310), in order to eliminate echo returned from second networking device 120 of FIG. 1, and thereafter, each frame of the PCM audio is analyzed by a voice activity detector (VAD). For example, the VAD may be software executed by processing unit 240 of FIG. 2 (block 320). Based on signal characteristics of each PCM audio frame, a determination is made whether the frame constitutes voice or silence (block 330).

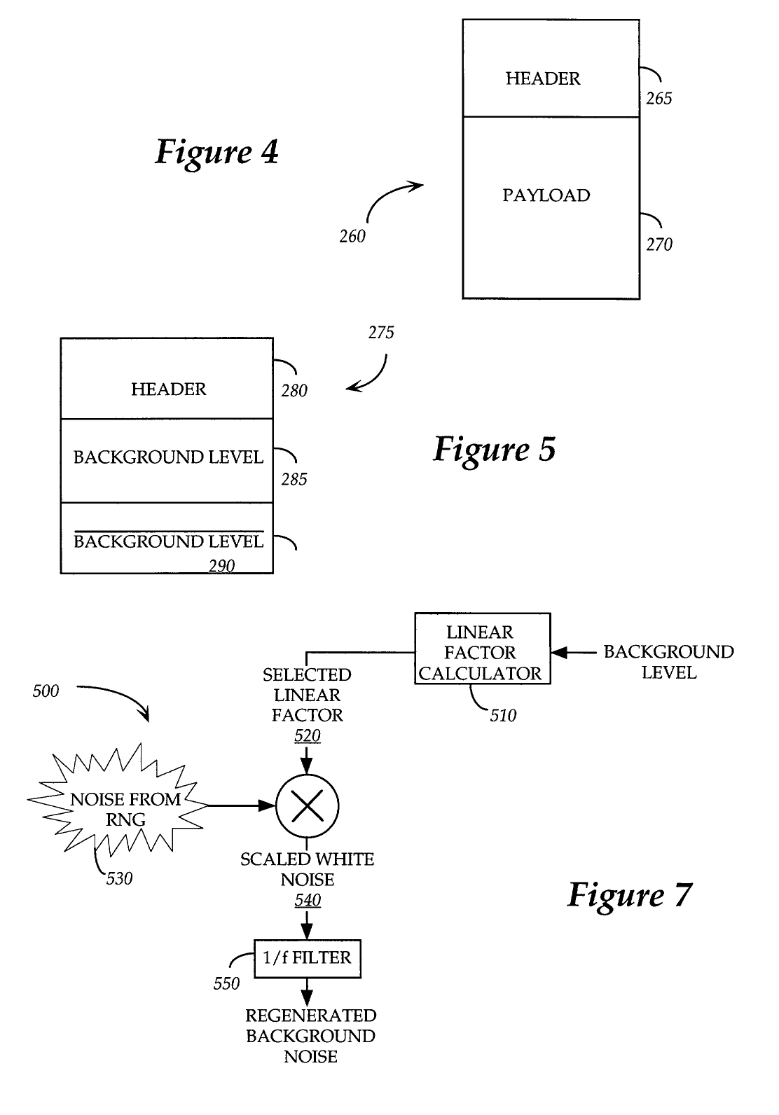

If the frame is determined to be voice, first networking device 110 enters into a VOICE mode. In this mode, the PCM audio frame is loaded into a speech coder which compresses the PCM audio frame to produce a service frame as shown in FIG. 4 (block 340). The service frame 260 includes a header 265 to identify the frame and payload 270 to contain compressed audio. Such compression is performed in accordance with any existing or later developed compression function.

Alternatively, if the frame is determined to be silence, first networking device enters into a SILENCE SUPPRESSION mode. In this mode, a silence suppression frame (see FIG. 5) is transmitted to the second networking device (block 350). The silence suppression frame 275 comprises a header 280, a first field 285 to contain a background noise level being an energy value representing the background noise, and a second field 290 to contain the complement of the background noise level. The complement is included for error checking. This process, inclusive of voice activity detection, continues for each PCM audio frame (block 360).

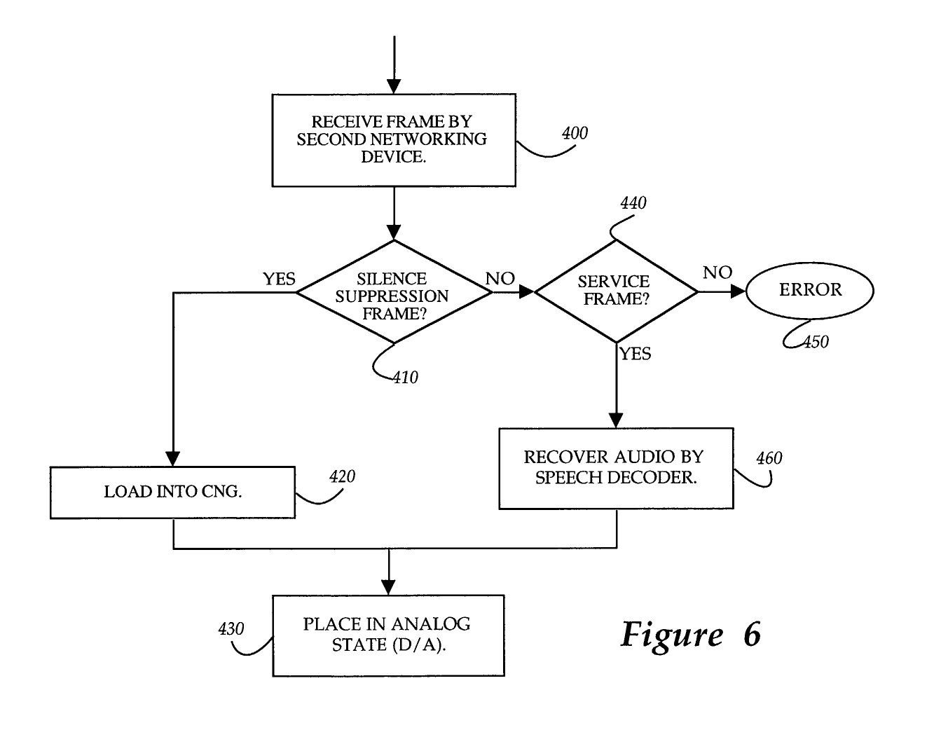

Referring now to FIG. 6, an illustrative flowchart of the operations performed by second networking device 120 of FIG. 1 is shown. Upon receiving a frame of information (block 400), second networking device 120 determines whether a silence suppression frame has been received (block 410). If so, the background noise level recovered from the silence suppression frame is loaded into a comfort noise generator (CNG). The CNG produces comfort noise samples based on the received background level in order to avoid audio artifacts such as in-out effects (block 420).

In particular, as shown in FIG. 7, CNG 500 includes linear factor calculator 510 to handle various ranges of background noise levels. Each of these ranges (in dB) is mapped into a linear factor 520 which is used to scale a constant level of noise 530 supplied by a random number generator. The scaled white noise 540 is then passed through a first order 1/f filter 550 to obtain the pink noise samples. The resultant pink noise is a regeneration of the background noise at the source. Thereafter, the pink noise samples are placed in an analog format (block 430) as shown in FIG. 6.

Referring still to FIG. 6, in the alternative event that a service frame is detected so no error condition is triggered (blocks 440-450), the service frame is transferred to a speech decoder to recover a substantial portion of the original PCM audio (block 460). Thereafter, the PCM audio is placed in an analog format (block 430).

Referring to FIG. 8, an illustrative flowchart of the operations of the voice activity detector (VAD) is shown. Initially, each audio frame is collected for N samples per frame (block 600). In this embodiment, the sampling number “N” is approximately 80 samples per frame, but may be any number of samples up to the size supported by a speech coder. After the audio frame has been collected, a number of signal parameters are calculated, including the short-term averaged energy, the long-term averaged energy, and the peak-to-mean likelihood ratio.

Before calculating the short-term averaged energy and the long-term averaged energy, the energy associated with the current audio frame is calculated (block 610). This is accomplished by squaring each voice sample (sᵢ) for the current audio frame and summing the squared result. The frame energy is defined by equation (3).

$$E = {\sum }_{i = 0}^{N - 1} {( {s}_{i} )}^{2} \qquad ( 3 )$$

After the current frame energy has been calculated, it is converted into a decibel (dB) value (block 620). This provides a larger dynamic range to handle a greater energy variance for each sampled audio frame. The frame energy (in dB) is calculated as shown in equation (4).

E_{dB}=10 log₁₀(E) (4)

After calculating E_{dB} for the current frame, the short term averaged energy may be calculated (block 630). The short-term averaged energy (STAE) is an accumulation of signal energy associated with successive PCM audio frames. The current frame energy E_{dB} and the STAE for the previous frame are weighted by predetermined factors “α” and “1−α” so that the resultant value is the STAE for the current frame. The selection of the factor “α” may be set through simulations. Herein, the STAE is defined in equation (5) as:

Eₛ(k)=α×E_{dB}(k)+(1−α)×Eₛ(k−1), (5)

where

$$α = \{ \begin{matrix}0.125 & if {E}_{dB} ( k ) \geq {E}_{s} ( k - 1 ) \\ 0.25 & otherwise .\end{matrix}$$

“α” denotes a selected factor of the energy of a current PCM audio frame to be added to the accumulated average.

“E_{dB}(k)” denotes the current frame energy in decibels; and

“Eₛ(k−1)” denotes the prior short-term averaged energy value.

Along with the STAE, the “long-term averaged energy” (LTAE) is calculated (block 640). The LTAE is defined as an additional level of accumulation to track the background noise level and, for this embodiment, is updated in accordance with equation (6):

$$\begin{matrix}{E}_{x} ( k ) = \{ \begin{matrix}min \{ β {E}_{x} ( k - 1 ) + ( 1 - β ) {E}_{s} ( k ) , & {E}_{max} \} , if {E}_{x} ( k - 1 ) > {E}_{s} ( k ) \\ min \{ {E}_{x} ( k - 1 ) + δ {S}_{x} , {E}_{max} \} , & otherwise\end{matrix} & ( 6 ) \\ where β = 0.875 \\ δ {E}_{x} = \{ \begin{matrix}1 & if previous form is voice , \\ \frac{1}{16} & otherwise .\end{matrix} & \end{matrix}$$

Eₘₐₓ denotes the maximum background level being set to −30 dBm0.

In the case where Eₓ(k−1)<Eₛ(k), instead of adaptively updating LTAE, we apply a jump (δEₓ). By doing so, we can update the LTAE promptly when there is a sudden change in background noise level.

Next, a peak-to-mean ratio (PMR) is calculated in order to determine the peak-to-mean likelihood ratio (block 650). The PMR comprises a ratio between the absolute value of a maximum sampled signal and the summation of the values for all (N) sampled signals for the current frame as shown in equation (7). Therefore, as the value of the PMR increases, there is a greater likelihood that the current frame represents silence because a waveform associated with silence has lesser energy than a waveform associated with voice.

$$PMR = \frac{max \{ \vert {s}_{i} \vert \}}{{\sum }_{i = 0}^{N - 1} \vert {s}_{i} \vert} \qquad ( 7 )$$

After the PMR is calculated, an average peak-to-mean ratio (APMR) is now determined (block 660) for use in calculating the peak-mean likelihood ratio (PMLR). The reason for calculating APMR is to prevent frequent alterations between VOICE mode and SILENCE SUPPRESSION mode based on environmental conditions (e.g., speaker talks loudly, noisy environment, etc.). Consequently, the occurrence of an in/out effect is substantially mitigated.

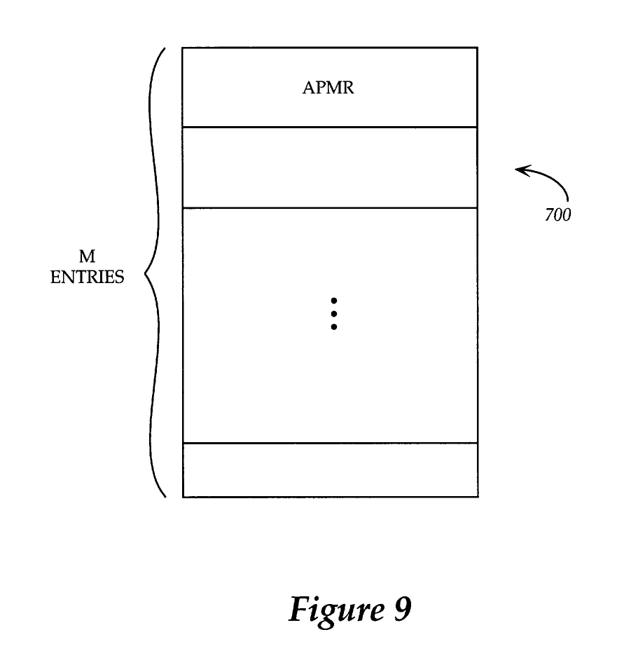

As shown in FIG. 9, one technique to calculate the APMR is to implement a circular buffer 700 having depth “M”. During analysis by the VAD, the PMR for that frame is inserted into buffer 700. After each insertion, the APMR is calculated by averaging all of the PMRs loaded into buffer 700 based on equation (8):

$$APMR = \frac{1}{M} {\sum }_{i = 0}^{M - 1} {PMR}_{i} \qquad ( 8 )$$

Referring back to FIG. 8, it is contemplated that the PMR and APMR may be used for voice activity detection. The behavior of PMR or APMR may vary, depending on the audible level of the speaker's voice or the background noise. Thus, in this embodiment, a normalized parameter, namely a peak-mean likelihood ratio, is calculated and subsequently used to determine whether a sampled frame represents voice or silence (block 670).

More specifically, the peak-mean likelihood ratio (PMLR) is a parameter which is compared with a predetermined threshold value to determine whether a sampled frame represents voice or silence. This threshold value is programmed during simulation, allowing a customer to select an acceptable tradeoff between voice quality and bandwidth savings.

As shown in equation (9) below, the PMLR is normalized to substantially mitigate modification caused by different speakers and different background noise levels. As a result, PMLR has minimal variation between audio frames in order to discourage in/out effects due to frequent switching between VOICE mode and SILENCE SUPPRESSION mode. Also, PMLR is independent of frame size, and thus, can operate with speech coders supporting different frame sizes.

To determine the PMLR, the VAD keeps track of the maximum APMR (APMRₘₐₓ) and the minimum APMR (APMRₘᵢₙ) contained in buffer 700 of FIG. 9. The contents of buffer 700 may be periodically cleared after a selected period of time has expired or after a selected number (S) of calls (S≧1). From these values and the APMR associated with the current audio frame, the PMLR can be measured by equation (9).

$${PMLR}_{k} = \frac{( {APMR}_{max} - {APMR}_{k} )}{( {APMR}_{max} - {APMR}_{min} )} \qquad ( 9 )$$

In block 680, based on the STAE, LTAE and PMLR parameters, the VAD performs a bifurcated decision process to determine whether a sampled audio frame is voice or silence. A first determination is whether the combination of the STAE and a selected factor is greater than the LTAE as shown in equation (10). The factor is set based on simulation results, which was determined to be 2 dB in this embodiment. Of course, as the factor is increased, more bandwidth will be conserved because there is greater probability for the system to be placed in a VOICE mode.

$$STAE + factor ( 2 dB ) {\geq }^{?} LTAE \qquad ( 10 )$$

If the combination is greater than the LTAE, the sampled audio frame is initially considered to be voice. As a result, the VAD performs a second determination. This determination involves ascertaining the PMLR when the LTAE and the STAE differ by less than a predetermined threshold. The predetermined threshold is determined to be 4 dB in this embodiment. In mathematical terms:

|LTAE−STAE|<Threshold (4 dB)

When this condition is met, the VAD determines whether the PMLR is less than a selected threshold. The selected threshold is determined to be 0.50 in this embodiment. If the PMLR is less than the selected threshold, the sampled audio frame represents silence. Otherwise, it represents voice. Consequently, the PMLR provides a secondary determination when the LTAE is approaching the STAE to avoid needless in/out effects.

Once the determination has been made that the sampled audio frame is voice or silence, the VAD performs a decision smoothing process (block 690). The decision smoothing function delays the system from switching from the VOICE mode to the SILENCE SUPPRESSION mode immediately after the current frame is detected to be silence. This avoids speech clipping at the end of an utterance.

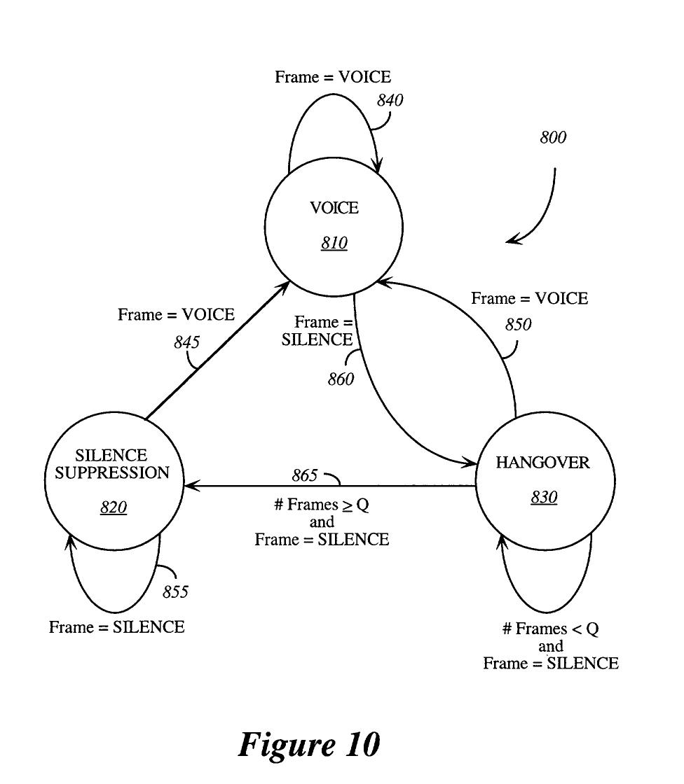

Referring now to FIG. 10, a state diagram concerning the operations of a decision smoothing state machine 800 of the VAD is shown. State machine 800 comprises a VOICE (mode) state 810, a SILENCE SUPPRESSION state 820 and a HANGOVER state 830. For each sampled audio frame, state machine 800 determines the operating state of the system. In the HANGOVER state 830, the system operates as in the VOICE state.

As shown, state machine 800 enters or remains in VOICE state 810 if the current audio frame is determined to be voice as represented by arrows 840, 845 and 850. However, when the current audio frame is determined to be silence, the operating mode of the system depends on the current state of state machine 800. For example, if state machine 800 is in SILENCE SUPPRESSION state 820, state machine 800 remains in that state as represented by arrow 855. However, if state machine 800 is in VOICE state 810 and the current audio frame is determined to be silence, state machine enters into HANGOVER state 830 as represented by arrow 860. Consequently, only after a predetermined number (Q) of subsequent audio frames are determined to be silence (# of frames≧Q), state machine 800 enters into SILENCE SUPPRESSION state 820 as represented by arrow 865. However, if prior to that time, the sampled audio frame is determined to be voice, state machine enters into VOICE state 810 as represented by arrow 850. As a result of these operations, speech clipping is substantially avoided.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A method for enhancing voice activity detection comprising:
determining a peak-to-mean likelihood ratio; and
comparing the peak-to-mean likelihood ratio to a selected threshold to determine whether a current audio frame represents a voice signal.

2. The method of claim 1, wherein prior to determining the peak-to-mean likelihood ratio, the method further comprises:
determining a short-term averaged energy for the current audio frame; and
determining a long-term averaged energy for the current audio frame.

3. The method of claim 2, wherein after determining the short-term averaged energy and the long-term averaged energy, the method further comprises:
determining whether a sum of the short-term averaged energy and a factor is greater than the long-term averaged energy; and
determining that the current audio frame represents silence if the sum is less than the long-term averaged energy, without necessitating a determination of the peak-to-mean likelihood ratio.

4. The method of claim 3, upon determining that the sum is greater than the long-term averaged energy and before determining the peak-to-mean likelihood ratio, the method further comprises:
determining whether a difference between the long-term averaged energy and the short-term averaged energy is less than a predetermined threshold;
determining that the current audio frame represents voice if the difference is greater than the predetermined threshold; and
continuing by determining the peak-to-mean likelihood ratio if the difference is less than the predetermined threshold.

5. The method of claim 2, wherein the determining of the short-term averaged energy comprises:
determining an energy, in decibels, of the current audio frame;
determining a short-term averaged energy for a prior audio frame; and
conducting a weighted average of the energy of the current audio frame and the short-term averaged energy for the prior audio frame.

6. The method of claim 1, wherein the determining a peak-to-mean likelihood ratio comprises
calculating an averaged peak-to-mean ratio for the current audio frame;
determining a maximum averaged peak-to-mean ratio;
determining a minimum averaged peak-to-mean ratio;
determining a first result being a difference between the maximum averaged peak-to-mean ratio and the averaged peak-to-mean ratio for the current audio frame;
determining a second result being a difference between the maximum averaged peak-to-mean ratio and the minimum averaged peak-to-mean ratio; and
conducting a ratio between the first result and the second result to produce the peak-to-mean likelihood ratio.

7. A communication module comprising:
a substrate;
a processing unit placed on the substrate; and
a memory coupled to the processing unit, the memory to contain a voice activity detector which, when executed by the processing unit, analyzes a short-term averaged energy, a long-term averaged energy, and a peak-to-mean likelihood ratio in order to determine whether a current audio frame represents voice or silence.

8. The communication module of claim 7, wherein the voice activity detector, when executed, controls the processing unit to determine whether a sum of the short-term averaged energy and a predetermined factor is greater than the long-term averaged energy, and to signal that the current audio frame represents silence if the sum is less than the long-term averaged energy.

9. The communication module of claim 8, wherein the voice activity detector, when executed, controls the processing unit to determine whether a difference between the long-term averaged energy and the short-term averaged energy is less than a predetermined threshold, and to signal that the current audio frame represents voice if the difference is greater than the predetermined threshold.

10. The communication module of claim 9, wherein the voice activity detector, when executed, controls the processing unit to determine the peak-to-mean likelihood ratio, and to compare the peak-to-mean likelihood ratio to a selected threshold to determine whether a current audio frame represents a voice signal.

11. The communication module of claim 10, wherein the voice activity detector, when executed, controls the processing unit to determine a peak-to-mean ratio by (i) sampling an analog signal a predetermined number of times to produce a plurality of sampled signals each having a sampled value, (ii) determining a maximum value of the plurality of sampled signals, and (iii) conducting a ratio between an absolute value of the maximum value and a summation of the sampled values for the plurality of sampled signals.

12. The communication module of claim 10, wherein the voice activity detector, when executed, controls the processing unit to determine an averaged peak-to-mean ratio for the current audio frame by (i) monitoring a maximum averaged peak-to-mean ratio and a minimum averaged peak-to-mean ratio, (ii) determining a first result being a difference between the maximum averaged peak-to-mean ratio and the averaged peak-to-mean ratio for the current audio frame, (iii) determining a second result being a difference between the maximum averaged peak-to-mean ratio and the minimum averaged peak-to-mean ratio, and (iv) conducting a ratio between the first result and the second result to produce the peak-to-mean likelihood ratio.

13. A machine readable medium having embodied thereon a computer program for processing by a machine, the computer program comprising:
a first routine for determining a peak-to-mean likelihood ratio; and
a second routine for comparing the peak-to-mean likelihood ratio to a selected threshold to determine whether an audio frame being transmitted represents a voice signal.

14. The machine readable medium of claim 13, wherein the computer program further comprising:
a third routine for determining a short-term averaged energy for the audio frame, the third routine being executed before the first and second routines; and
a fourth routine for determining a long-term averaged energy for the audio frame, the fourth routine being executed before the first and second routines.

15. The machine readable medium of claim 14, wherein the computer program further comprising:
a fifth routine for determining whether a sum of the short-term averaged energy and a predetermined factor is greater than the long-term averaged energy, the fifth routine being executed before the first and second routines; and
a sixth routine for determining whether a difference between the long-term averaged energy and the short-term averaged energy is less than a predetermined threshold, the sixth routine being executed after determining that the sum is greater than the long-term averaged energy and before execution of the first and second routines.

16. The machine readable medium of claim 15, wherein the fifth routine determining that the current audio frame represents silence if the sum is less than the long-term averaged energy.

17. The machine readable medium of claim 15, wherein the sixth routine determining that the current audio frame represents voice if the difference is greater than the predetermined threshold.

18. A voice activity detector comprising:
circuitry to determine a short-term averaged energy for an audio frame;
circuitry to determine a long-term averaged energy for the audio frame;
circuitry to determine whether the short-term averaged energy is greater than the long-term averaged energy by a predetermined factor;
circuitry to determine whether a difference between the long-term averaged energy and the short-term averaged energy is less than a predetermined threshold when the short-term averaged energy is greater than the long-term averaged energy by the predetermined factor;
circuitry to determine a peak-to-mean likelihood ratio when the difference between the long-term averaged energy and the short-term averaged energy is less than the predetermined threshold; and
circuitry to comparing the peak-to-mean likelihood ratio to a selected threshold and to determine that the audio frame represents a voice signal when the peak-to-mean likelihood ratio is greater than a selected threshold.
